(19) United States
(12) Patent Application Publication
(10) Pub. No.: US 2003/0180408 A1
(43) Pub. Date: Sep. 25, 2003

(54) Path-measuring system for powder press

(76) Inventors: Jurgen Hinzpeter, Schwarzenbek (DE); Ingo Schmidt, Schwarzenbek (DE); Andreas Groth, Schwarzenbek (DE); Andreas Teetzen, Schwarzenbek (DE); Thomas Pannewitz, Schwarzenbek (DE); Udo Baltruschat, Hamburg (DE); Thorsten Ehrich, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/391,969

(22) Filed: Mar. 19, 2003

(30) Foreign Application Priority Data
Mar. 20, 2002 (DE) 102 12 315.2

(51) Int. Cl. B29C 43/58

(52) U.S. Cl. 425/140; 425/167; 425/406

(57) ABSTRACT

Path-measuring system for a powder press which has at least one top and one bottom stamping die, which co-operate with a mould of a mould plate and are each one actuated by a hydraulic cylinder, a laterally projecting index arm on the top and the bottom stamping die, which co-operates with an assigned vertical measuring ruler, and the measurement results are transmitted to a machine computer, characterised in that at least two index arms on opposing sides on at least the top and the bottom stamping die co-operate with a measuring ruler, and the machine computer compensates an incorrect measurement value on one measuring ruler by the second measurement value on the other measuring ruler.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

For the production of pellets which are accurate in dimension, the positioning accuracy of top- and bottom stamping dies of a powder press, for instance a metal powder press, is of great importance. An accuracy of 0.01 mm has to be maintained.

A path measurement can be obtained by determining the path of the piston of a hydraulic cylinder which actuates the stamping die. Resulting from the forces which occur on pressing, a stretching of the machine frame and, as the case may be, even a forging of the stamping die and the piston rod takes place. Then, the measured values do no more correspond to the real ones. If the mould has a tapered form, a bending of the mould table further takes place. Therefore, a path measuring on the hydraulic cylinders may only serve as a coarse measurement.

From DE 199 19693 it has become known to obtain a determination of the position of a stamping die with regard to a mould by performing the determination of position with the aid of an incremental displacement transducer, when the stamping die approaches the mould. To ascertain the transition without errors, a reference dimension is stored in a computer, which corresponds to a predetermined, relatively small distance of the stamping die to the top or bottom edge of the mould. Furthermore, a reference offset is stored in the computer, which is determined by counting the impulses of an incremental displacement transducer, actuated by the stamping die, when bringing up the stamping die from the reference dimension to the indexing impulse. Upside of the reference offset, the position of the stamping die is measured with the aid of the already mentioned absolute displacement transducer, which determines the path of the piston. As soon as the initial position of the stamping die is equal to or smaller than the accumulated dimension of reference offset and reference dimension, the impulses of the incremental displacement transducer for positioning are transmitted to the computer.

Due to reasons of construction, it is not possible to dispose the incremental measuring system in the axis of the stamping dies. Instead, an index arm has to be attached on the stamping dies, which co-operates with an excentrically disposed vertical measuring ruler, which is constructed as an incremental displacement transducer, for instance. In such a measuring system, measurement errors can also occur, however. Thus, tilting of the index arm or bending, respectively, may take place through friction of the index arm with the measuring ruler. A further corruption of the measuring result can take place thereby that the stamping die experiences an inclination by tilting, which is conveyed to the projecting arm. The described error becomes serious particularly, when e.g. in a stamping die a so-called centre pin is guided, which is also actuated by a hydraulic cylinder and the path of which is also to be determined exactly. Due to conditions of construction the path-measuring system has to be disposed relatively far outside of the central axis of the centre pin. Deviations of the centre pin from its central position or deformations or pannings, respectively, therefore lead to particularly serious measuring errors.

The invention has as an objective to provide a path measuring system for a powder press in which measuring errors with an excentrically arranged path measuring system can be compensated for.

### BACKGROUND SUMMARY OF THE INVENTION

In the inventive path measuring system, at least two index arms are arranged on opposing sides on at least the top and the bottom stamping die, and each index arm co-operates with a measuring ruler. The measurement values are transmitted to the computer, one incorrect measurement value being compensated by the second one.

In the invention it is presupposed that e.g. upon a change of position of the index arm due to a friction with the measuring ruler, the other index arm correspondingly experiences a displacement into the opposite direction. This is particularly the case when both the index arms are formed by one common lever, the measuring rulers being disposed on diametrically opposing sides of the stamping die.

A displacement of an index arm can also take place thereby that the index arms are guided by a linear vertical guiding. In fact, the guidings should assist in avoiding a displacement of the index arms, but they do not always succeed in doing this, however. Even on this occasion, the displacement of the index arm on the one side of the stamping die would induce an opposite displacement of the index arm on the opposing side.

As mentioned above, a further corruption of the measurement result is obtained thereby that the stamping die tilts with respect to the exact vertical axis. However, the tilting of the stamping die towards all possible sides can only then be taken hold of if at least three measuring systems are provided, which are preferably disposed equidistantly on the diameter. Their measurement results are processed in the computer, so that the path which was really covered by the stamping die can be measured.

### BRIEF DESCRIPTION OF SEVERAL VIEWS OF THE DRAWINGS

The invention is subsequently elucidated in more detail by means of figures.

FIG. 1 schematically shows a lateral view of a powder press with measuring systems according to the invention.

FIG. 2 shows a detail of the powder press after FIG. 1, with a path-measuring system according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

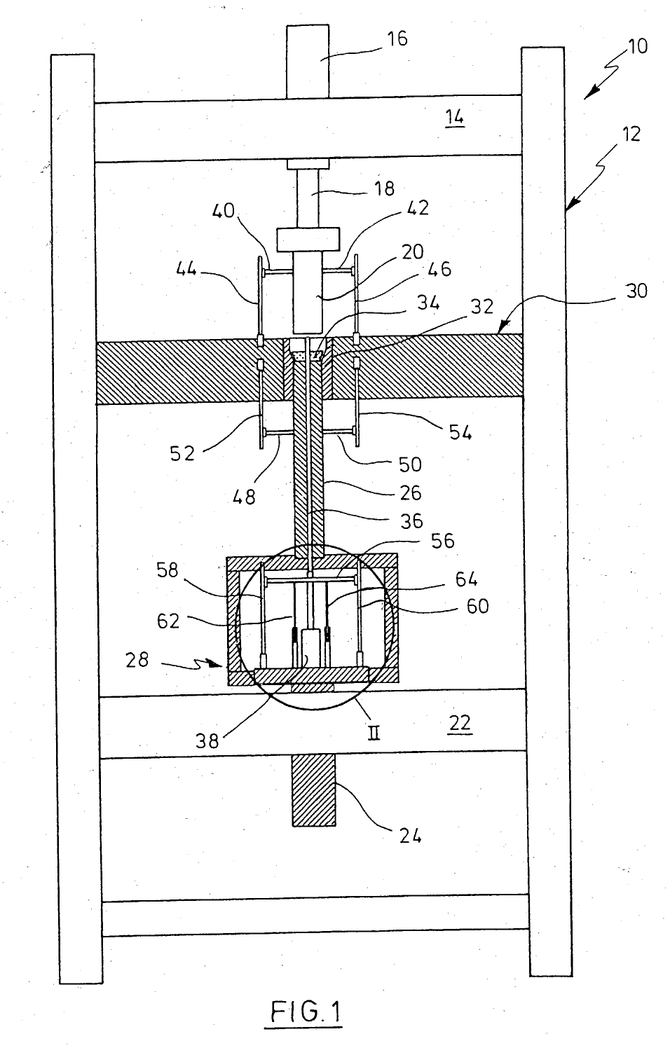

In FIG. 1, a powder press 10 can be recognised, which has a frame 12. An upper plate 14 of the frame mounts a hydraulic cylinder 16, the piston 18 of which actuates a top stamping die 20. A bottom plate 22 of the frame 12 mounts a bottom hydraulic cylinder 24, which actuates a bottom stamping die 26, namely by intercalation of a box-shaped structural member 28, to which shall be referred to later. A mould plate 30 is fixedly disposed in the frame 12 and accommodates in a bore a mould 32, with which top and bottom die stamps 20, 26 co-operate for the production of a pellet 34, as shown.

A centre pin 36 extends through the central axial bore of the stamping die 26, which is actuated by a hydraulic cylinder 38. The hydraulic cylinder 38 is supported on the bottom of the box-shaped part 28. It serves for the production of a central hole in the pellet 34.

An arm 40 and 42, respectively, is connected on diametrically opposing sides with the top stamping die 20, co-operating in a slipping manner with a vertical measuring ruler 44 or 46, respectively, as is known in principle. For instance, it is dealt with incremental distance transducers, as known in principle. The measuring rulers 44, 46 are fixedly connected to the mould plate 30. With the aid of the measuring rulers it is possible to determine the exact path of the top stamping die 20 in relation to the mould plate 30.

With the aid of index arms 48, 50 on the bottom stamping die 26 and the measuring rulers 52, 54, which are connected to the bottom side of the mould plate 30, the exact path of the bottom stamping die 26 relative to the mould plate can be determined also.

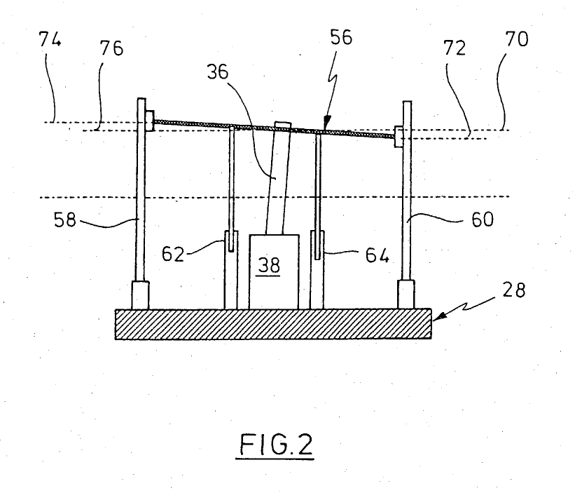

A cross bar 56 is connected inside of the box-shaped structural member 28 with the centre pin 36, which forms an index arm on opposing sides of the centre pin 36, comparable to the index arms 40, 42 and 48, 50, respectively. They co-operate with measuring rulers 58 and 60, respectively, inside of the structural member 28. On both opposing sides of the centre pin 36 and the hydraulic cylinder 38, respectively, linear vertical guidings 62 and 64 are disposed, respectively. They serve to guide the movements of the index arms of the bar 56 in such a manner that it moves in an accurately horizontal plane with the centre pin 36,so that the measuring rulers 58, 60 determine the accurate path. This is because a displacement of the index arms can take place in spite of the guidings 62, 64, however, as represented in FIG. 2. If only one measuring system were used, e.g. the right-side one in FIG. 2, a difference would result between actually covered path 70 and measured path 72 upon displacement of the right index arm. In the present representation, the difference is attributed to the tilting of centre pin 36 (shown in a disproportionate manner). Because a second measuring system is provided on the left sides in FIGS. 1 and 2, the measured path 74 is larger than the actually run path 76. In the present case, the measured error can be compensated for by averaging, and thus the actually covered path of the centre pin 36 can be obtained. It is to be realised that this compensation principle can also be applied to the measuring systems for the top and bottom stamping die, as represented in FIG. 1. If only a compensation of the displacement of the index arms is aimed at, the use of two measuring systems, preferably on diametrically opposing sides of the stamping die and the centre pin, respectively, is sufficient. If a tilting of the stamping die and the centre pin is to be detected also, however, at least three measuring systems of the delineated type are required to obtain a compensation, which are preferably offset at an angle of 120 degrees.

The above Examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. Path-measuring system for a powder press which has at least one top and one bottom stamping die, which co-operate with a mould of a mould plate and are each one actuated by a hydraulic cylinder, a laterally projecting index arm on the top and the bottom stamping die, which co-operates with an assigned vertical measuring ruler, and the measurement results are transmitted to a machine computer, characterised in that at least two index arms on opposing sides on at least the top and the bottom stamping die co-operate with a measuring ruler, and the machine computer compensates an incorrect measurement value on one measuring ruler by the second measurement value on the other measuring ruler.

2. Path-measuring system according to claim 1, characterised in that at least three measuring systems are arranged in equal diameter distance on the top and the bottom stamping die.

3. Path-measuring system according to claim 1, characterised in that a vertical linear guiding is assigned to the arms, and that the guidings, measuring rulers and the arms of one measuring system are arranged in one plane.
